(19) United States
(12) Patent Application Publication
(10) Pub. No.: US 2006/0217146 A1
(43) Pub. Date: Sep. 28, 2006

(54) Radio resource management and reuse scheme in multi-standard wireless communication system

(76) Inventors: Jiang Cheng, Shanghai (CN); Ni Ma, Shanghai (CN); Li Sun, Shanghai (CN); Xuejun Zhang, Shanghai (CN)

Correspondence Address: PHILIPS INTELLECTUAL PROPERTY & STANDARDS, P.O. BOX 3001, BRIARCLIFF MANOR, NY, 10510, US

(21) Appl. No.: 10/540,691

(22) PCT Filed: Dec. 23, 2003
(86) PCT No.: PCT/IB03/06173

§ 371 Date: Apr. 14, 2006

(30) Foreign Application Priority Data
Dec. 27, 2002 (CN) 02159000.1

(51) Int. Cl. H04M 1/00

(52) U.S. Cl. 455/552.1; 455/450; 455/509; 455/436

(57) ABSTRACT

A method for RF resource management in multi-standard wireless communication system, comprises: adding a system type identification element in downlink information; allocating RF resources among different wireless communication schemes; and corresponding the different wireless communication schemes which have been allocated said RF resources to different values of said system type identification element.

### FIELD OF THE INVENTION

The present invention relates to multi-standards wireless communication system; and, more particularly, to a method for identifying RF resources in RF resources management of multi-standard communication system.

### BACKGROUND OF THE INVENTION

With the development of mobile communication systems, more and more communication standards (i.e. wireless communication schemes) came into emergence, e.g., GSM, IS-95 and CDMA, which belong to the second generation (2G) wireless communication scheme, GPRS and TSM, which belong to the from-2G-to-3G wireless communication scheme, TD-SCDMA, W-CDMA and cdma2000, which fall into the third generation (3G) wireless communication scheme, and even WLAN, another popular wireless communication scheme, and etc.

According to the regulation of ITU, different wireless communication schemes are required to transmit data with different frequency bands. However, with the rapid development of communication services, various wireless communication schemes appeared, i.e., different wireless communication schemes will transmit data with different carriers in the same frequency band. Typically, TSM proposed by CWTS (China Wireless Communication Standard group) shares the same frequency band with TD-SCDMA.

TD-SCDMA is a TDD-mode wireless communication scheme to transmit data with SCDMA (synchronous code division multiple access) technology, while TSM is designed as an evolving wireless communication scheme from existing system with GSM wireless communication scheme to the system with TD-SCDMA wireless communication scheme, which combines the core network of GSM/GPRS with the RF transmission technology of TD-SCDMA, and is able to provide 3G data services before the real TD-SCDMA services are launched.

TSM is only designated as an interim wireless communication scheme to smoothly evolve into TD-SCDMA when it was originally designed, so TSM shares the same frequency band with TD-SCDMA to transmit data. However, with the growing of TSM, it is very likely that the communication system with TSM wireless communication scheme will be still in use after the communication system with TD-SCDMA wireless communication scheme is launched, i.e., TSM and TD-SCDMA wireless communication schemes will have to co-exist in our communication environment to transmit data within the same frequency band, and maybe for a long time. Hence, the problem will arise as how to distinguish the two wireless communication schemes and have a mobile terminal precisely access the mobile communication system with the corresponding wireless communication schemes.

With regard to the problem above of RF resources sharing, a solution is to assign RF carriers available in a frequency band fixedly to TSM and TD-SCDMA wireless communication schemes respectively according a certain criteria, i.e., some RF carriers are assigned to TSM wireless communication scheme, while others to TD-SCDMA wireless communication scheme.

To a certain extent, the problem of RF resources sharing can be solved by to assigning RF carriers fixedly, but this fixed configuration method is obviously far from flexible. It advances as a problem to be settled in modern communication field to allocate RF resources conveniently for different wireless communication schemes to transmit data within the same frequency band, and make it possible for mobile terminals to identify different wireless communication schemes accurately.

### SUMMARY OF THE INVENTION

One object of the invention is to provide a RF resources management method for multi-standard wireless communication system, which capable of identifying the wireless communication schemes used by the serving system, and thus having mobile terminals access the system correctly.

Another object of the invention is to offer a RF resources management method for multi-standard wireless communication system, by which a mobile terminal can save the overhead of a cell handover when not supporting the wireless communication scheme used by the adjacent cell to be accessed.

Another purpose of the invention is to supply a RF resources management method for multi-standard wireless communication system, which capable of allocating RF carriers flexibly to each wireless communication scheme of the co-existing system.

To achieve the object above, a RF resources management method for multi-standard wireless communication system, as proposed in the present invention, comprising:

Adding a system type identification element in the downlink information;

Allocating RF resources to different wireless communication schemes; and

Corresponding the different wireless communication schemes that have been allocated said RF resources to different values of said system type identification element.

To attain the object above, a RF resources management method for a mobile terminal to access the wireless communication system, as proposed in the present invention, comprising:

Receiving the downlink information transmitted via a downlink;

Acquiring the value of the system type identification element in said downlink information;

Judging whether the mobile terminal supports the wireless communication scheme corresponding to said value of the system type identification element, according to said value of the system type identification element contained in said downlink information and the configuration of said mobile terminal; and

Accessing the wireless communication system with the wireless communication scheme, if the mobile terminal supports the wireless communication scheme corresponding to said value of the system type identification element.

To reach the purpose above, an apparatus for a mobile terminal to access the wireless communication system, as proposed in the present invention, comprising:

A receiving means, for receiving downlink information transmitted via a downlink;

A detecting means, for acquiring the value of the system type identification element in said downlink information;

A judging means, for judging whether the mobile terminal supports a wireless communication scheme corresponding to said value of the system type identification element according to said value of the system type identification element contained in said downlink information and the configuration of said mobile terminal;

An accessing means, for accessing the wireless communication system with the wireless communication scheme if the mobile terminal supports the wireless communication scheme corresponding to said value of the system type identification element.

To realize the purpose above, a mobile terminal, as proposed in the present invention, comprising:

A transmitting means, for transmitting wireless signals via an uplink;

A receiving means, for receiving wireless signals transmitted via a downlink;

An accessing means, for accessing wireless communication system, wherein the accessing means can judge whether the mobile terminal supports a wireless communication scheme corresponding to the value of the system type identification element according to said value of the system type identification element received and acquired by said receiving means from wireless signals of the downlink and the configuration of said mobile terminal, and help the mobile terminal access the wireless communication system with the wireless communication scheme if the mobile terminal supports the wireless communication scheme corresponding to said value of the system type identification element.

### BRIEF DESCRIPTION OF THE DRAWINGS

Further description will be given below, in conjunction with the accompanying figures, wherein:

FIG. 1 presents the structure of a cellular communication system;

FIG. 2 illustrates the structure of each cell in the cellular communication system of FIG. 1;

FIG. 3 diagrams the structure of the new system information message;

FIG. 4 is the flow chart of a mobile terminal accessing system;

FIG. 5 charts the cell handover procedure of a mobile terminal; and

FIG. 6 is the block diagram of an apparatus to access the wireless communication system.

### DETAILED DESCRIPTION OF THE PREFERRED EMBODIMENTS

This invention solves the problem of RF resources sharing between different wireless communication schemes to transmit data within the same frequency band, by adding a System Flag Element (SFE) to existing system information message. According to the predefined corresponding relationship between the values of SFE and the wireless communication schemes, a mobile terminal can accurately access a communication system with corresponding wireless communication scheme.

FIG. 1 demonstrates a cellular wireless communication system, wherein, A, B, C, D, E, Z represents 6 cells respectively. The 6 cells constitute a wireless communication system where cell Z is the center cell, and cell A-E are adjacent cells of cell Z. As the wireless communication system shown in FIG. 1, multiple wireless communication schemes can be employed between cells or within the same cell.

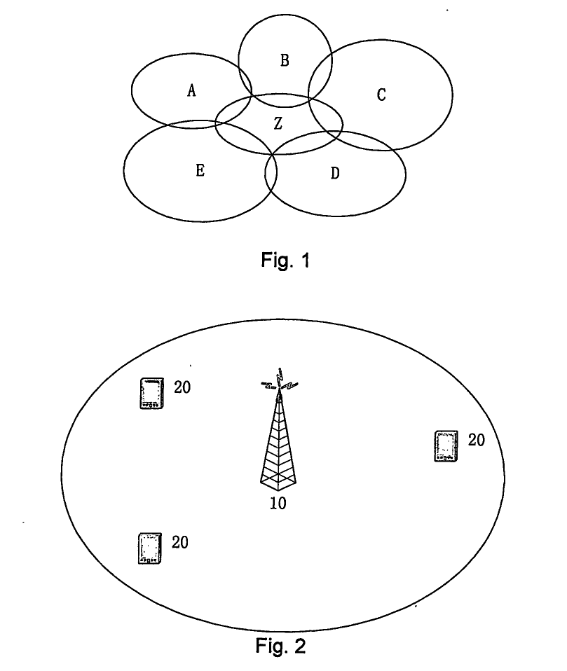

Every cell in FIG. 1 comprises a base station 10 (or namely Node B), and one or many mobile terminals 20. As best shown in FIG. 2, whether each mobile terminal 20 can access the wireless communication system of the current cell when it powers on, or access the wireless communication system of the adjacent cell, depends upon its configuration, i.e., the mobile terminal 20 may access a wireless communication system with TSM wireless communication scheme of if it supports TSM wireless communication scheme; and the mobile terminal 20 may also access a wireless communication system with TD-SCDMA wireless communication scheme if it supports TD-SCDMA wireless communication scheme.

A preferred embodiment will exemplify communication system where TSM and TD-SCDMA wireless communication schemes coexist, to present the RF resources management method for multi-standard wireless communication system, as proposed in the present invention. It is noted that the mobile terminal 20 described in the embodiment of the invention should support both TSM and TD-SCDMA wireless communication schemes, so as to be able to access a communication system with TSM or TD-SCDMA wireless communication scheme, as suggested in the RF resources management method of the present invention.

As described above, a mobile terminal can't distinguish TSM and TD-SCDMA wireless communication schemes only according to the RF frequency band used in communication environment where TSM and TD-SCDMA wireless communication schemes coexist, because the two wireless communication schemes transmit data within the same frequency band.

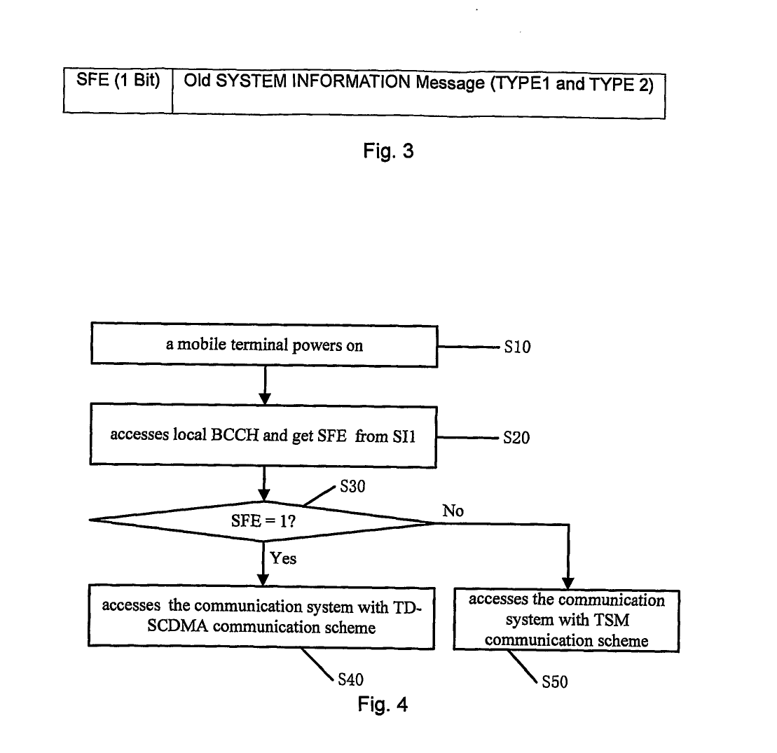

In this invention, a system type identification element is added into the existing system information message of the RF resources management protocol, as indicated in FIG. 3, and it could be one-bit SFE added into the existing system information message. In the new system information message, the part of the old system information message is composed of TYPE1 message (abbreviated as SI1) for wireless communication scheme used by the current cell and TYPE2 message (abbreviated as SI2) for wireless communication scheme used by the adjacent cells.

Herein, when a mobile terminal powers on to access the current cell or switches to the adjacent cell during cell handover, it can obtain the above said system information message over BCCH.

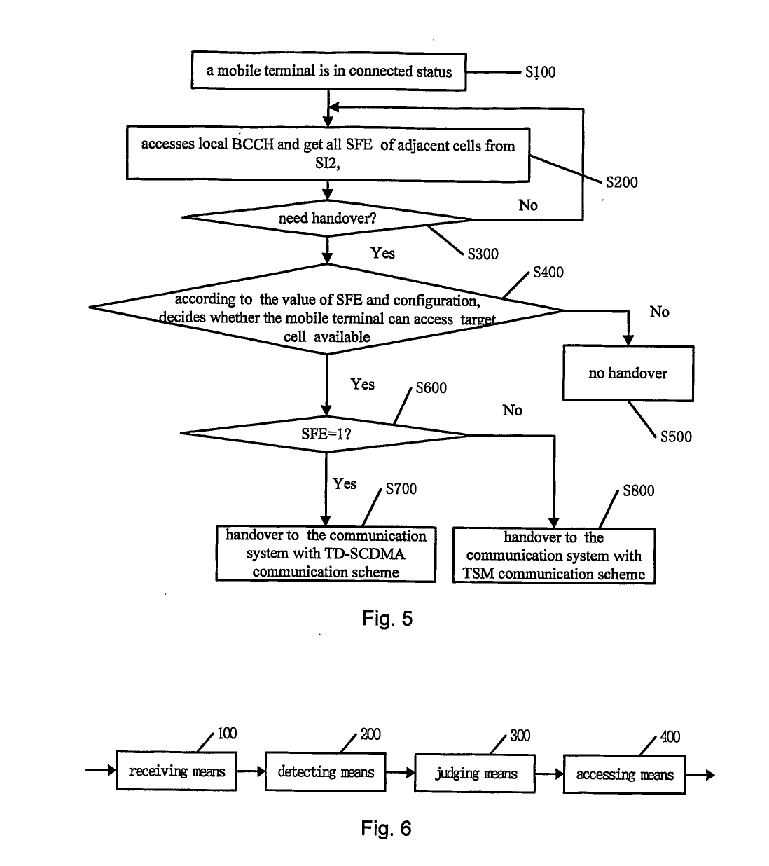

FIG. 4 and FIG. 5 demonstrate how a mobile terminal implements RF resources management in a multiple communication schemes co-existing communication system by SFE obtained in the system information message, when it accesses the current cell or switches to a adjacent cell during cell handover.

As shown in FIG. 4, when a mobile terminal is powered on in a cell (S10), it has no knowledge of the wireless communication scheme used by the current cell. By accessing the local BCCH, the mobile terminal receives said system information message (S20). As noted above, said system information message includes SI1 indicating the wireless communication scheme used by the current cell, the value of SFE can be obtained from SI1 according to the predefined corresponding relationship between the wireless communication schemes and the values of SFE, to and then the mobile terminal will access the communication system with the wireless communication scheme corresponding to the value of SFE (S30).

Assumed that SFE=1 represents a communication system with TD-SCDMA wireless communication scheme and SFE=0 for a communication system with TSM wireless communication scheme, the mobile terminal will access the communication system with TD-SCDMA wireless communication scheme when SFE=1 (S40), and the communication system with TSM wireless communication scheme when SFE=0 (S50).

FIG. 5 displays the procedure of the mobile terminal accessing a adjacent cell in the cell handover process, where the handover between the communication system with TSM and TD-SCDMA wireless communication scheme is involved.

While in connected status (S100), a mobile terminal receives said system information message by accessing the local BCCH. According to SI2 in the system information message, the mobile terminal can obtain all SFEs about the adjacent cells and accordingly catch all wireless communication schemes used by the adjacent cells (S200). Then the mobile terminal collects the signal power levels of the current cell and the adjacent cells, so as to decide whether cell handover is needed (S300). When the mobile terminal is to make a cell handover to a adjacent cell, it will judge whether it can access the target adjacent cell according to its configuration, i.e., which wireless communication schemes it supports (S400). If the mobile terminal can access the target adjacent cell, it will switch to the communication system with corresponding wireless communication scheme according to the value of SFE (S600), i.e., when SFE equals to 1, the mobile terminal will switch to the communication system with TD-SCDMA wireless communication scheme (S700) and to the communication system with TSM wireless communication scheme when SFE equals to 0 (S800), however, the cell handover won't be done if the mobile terminal doesn't support the wireless communication scheme used by the target adjacent cell (S500).

As stated above, during cell handover, the value of SFE is needed to decide whether the mobile terminal supports the wireless communication scheme used by the target adjacent cell and then make relevant decisions. Therefore, when the mobile terminal doesn't support the wireless communication scheme used by the target adjacent cell, the overhead caused by executing cell handover procedures can be saved.

Said mobile terminal 20 decides to access the communication system with TSM wireless communication scheme or the communication system with TD-SCDMA wireless communication scheme in power-on or cell handover status, according to the value of SFE. The access procedure can be implemented with software or hardware.

FIG. 4 and FIG. 5 show the way to be implemented with software. If implemented with hardware, the mobile terminal 20 needs to add a device for accessing wireless communication scheme, as shown in FIG. 6, which consists of: a receiving means 100, receiving downlink information transmitted via a downlink; a detecting means 200, acquiring the value of the system type identification element in said downlink information; a judging means 300, judging whether the mobile terminal supports the wireless communication scheme corresponding to said value of the system type identification element according to said value of the system type identification element contained in the downlink information and the status and the configuration of the mobile terminal; an accessing means 400, accessing the wireless communication system with wireless communication scheme if the mobile terminal supports the wireless communication scheme corresponding to said value of the system type identification element.

Additionally, TD-SCDMA is based on TDD mode, i.e., the uplink and the downlink share the same RF carriers, therefore, in the embodiment above, several different unpaired RF carriers can be used for the communication system with TSM communication scheme and the communication system with TD-SCDMA communication scheme respectively, and the values of SFE corresponding to different wireless communication schemes can be set by OA&M (Operation, Assistance & Maintenance) software in light of the traffic loads, so as to be able to flexibly and dynamically allocate the RF resources in multi-standard co-existing system.

Meanwhile, it needs to be clarified that a one-bit SFE is used to represent two wireless communication schemes of TSM and TD-SCDMA. A multi-bit SFE can be used to represent multiple wireless communication schemes, if there are more different wireless communication schemes within the same frequency band. The value of said SFE can also be set by OA&M software in light of the traffic loads.

As described above, the RF resources management method for multi-standard wireless communication system, as provided in the present invention, can be summarized as:

First, allocating RF resources to wireless communication schemes, i.e., allocating RF resources in different bands to different wireless communication schemes, or allocating different RF carriers within the same band to different wireless communication schemes.

Afterwards, adding a system type identification element corresponding to the wireless communication schemes to the system information transmitted via the downlink, i.e., every wireless communication scheme with a definite RF resources or RF carriers is corresponding to a definite value of the system identification element.

Thereby, a mobile terminal obtains said system type identification element via the downlink and determines whether it can access the wireless communication system with the corresponding wireless communication scheme.

The embodiment above provided by the invention, describes an example of allocating RF carriers between TD-SCDMA and TSM wireless communication schemes within the same band. According to the corresponding relationship between the two wireless communication schemes and the RF carriers within the same band, and the corresponding relationship between the two wireless communication schemes and the values of SFE, a mobile terminal can correspondingly access the communication system with TSM or TD-SCDMA wireless communication scheme by the value of SFE.

The same approach also goes true to allocate RF resources in different bands to different wireless communication schemes. According to the corresponding relationship between different wireless communication schemes and the allocated RF resources in different bands, and the corresponding relationship between different wireless communication schemes and the values of SFE, a mobile terminal can access a mobile communication system with corresponding wireless communication scheme.

In this invention, SFE as flag signal is added to the system information message of RF resources management protocol, so the serving wireless communication scheme can be identified according to the value of SFE, and thus a mobile terminal that supports said wireless communication scheme may access the corresponding communication system.

Further, during a cell handover, a step is added according to the value of SFE to decide whether a mobile terminal supports the wireless communication scheme used by the target adjacent cell. Therefore, when the mobile terminal doesn't support wireless communication scheme used by the target adjacent cell, the overhead caused by executing the cell handover procedures can be saved.

Meanwhile, setting the corresponding relationship between the values of SFE and different wireless communication schemes with software, this invention can allocate RF resources for multi-standard co-existing system flexibly.

Of course, to those skilled in the art, the RF resources management method for multi-standard wireless communication system as proposed in this invention, may not be limited to communication system with TSM or TD-SCDMA wireless communication scheme, but also may be applied in communication system with other multiple wireless communication schemes.

While the invention has been shown and described with respect to the preferred embodiments, it will be understood by those skilled in the art that various changes and modifications may be made without departing from the scope of the invention. Therefore, the scope of the invention to be protected needs to be determined by what is claimed.

1. A method for RF resources management in multi-standard wireless communication system, comprising:
adding a system type identification element in downlink information;
allocating RF resources to different wireless communication schemes; and
corresponding the different wireless communication schemes which have been allocated said RF resources to different values of said system type identification element.

2. The method of claim 1, further including:
allocating RF resources within the same frequency band to the different wireless communication schemes; and
corresponding the different wireless communication schemes which have been allocated said RF resources in the same frequency band to said different values of said system type identification element.

3. The method of claim 1, wherein said system type identification element is a set bit to identify the different wireless communication schemes.

4. The method of claim 1, wherein said downlink includes broadcast channel.

5. The method of claim 1, wherein said wireless communication schemes include at least two of following: IS-95, CDMA, GSM, TSM, GPRS, TD-SCDMA, W-CDMA, CDMA 2000 and WLAN.

6. A method for a mobile terminal accessing wireless communication system, comprising:
receiving downlink information transmitted via a downlink;
acquiring the value of the system type identification element in said downlink information;
judging whether the mobile terminal supports the wireless communication scheme corresponding to said value of the system type identification element according to said value of the system type identification element contained in said downlink information and the configuration of said mobile terminal; and
accessing the wireless communication system with the wireless communication scheme, if the mobile terminal supports the wireless communication scheme corresponding to said value of the system type identification element.

7. The method of claim 6, wherein when the status of the mobile terminal is power-on, said value of the system type identification element is the value of system type identification element of the current cell and said wireless communication scheme is the wireless communication scheme employed by the current cell.

8. The method of claim 6, wherein when the status of the mobile terminal is cell handover, said value of the system type identification element is the value of system type identification element of a adjacent cell and said wireless communication scheme is the wireless communication scheme employed by the adjacent cell.

9. The method of claim 8, wherein if the mobile terminal cannot access the wireless communication scheme corresponding to the value of the system type identification element of the adjacent cell, a cell handover will not be executed.

10. The method of claim 6, wherein said downlink includes broadcast channel.

11. A device for mobile terminals accessing to wireless communication system, comprising:
a receiving means, receiving downlink information transmitted via a downlink;
a detecting means, acquiring the value of the system type identification element in said downlink information;
a judging means, judging whether the mobile terminal supports the wireless communication scheme corresponding to said value of the system type identification element according to said value of the system type identification element contained in said downlink information and the configuration of said mobile terminal; and
an accessing means, accessing the wireless communication system with the wireless communication scheme if the mobile terminal supports the wireless communication scheme corresponding to said value of the system type identification element.

12. The device of claim 11, wherein when the status of the mobile terminal is power-on, said value of the system type identification element is the value of system type identification element of the current cell and said wireless communication scheme is the wireless communication scheme employed by the current cell.

13. The device of claim 11, wherein when the status of the mobile terminal is cell handover, said value of the system type identification element is the value of system type identification element of a adjacent cell and said wireless communication scheme is the wireless communication scheme employed by the adjacent cell.

14. The device of claim 13, wherein if the mobile terminal cannot access the wireless communication scheme corresponding to the value of the system type identification element of the neighbor cell, a cell handover will not be executed.

15. The device of claim 11, wherein said downlink includes broadcast channel.

16. A mobile terminal, comprising:
a transmitting means, transmitting wireless signals via a uplink;
a receiving means, receiving wireless signals transmitted via a downlink;
an accessing means for accessing wireless communication system, wherein the accessing means can judge whether the mobile terminal supports the wireless communication scheme corresponding to the value of the system type identification element according to said value of the system type identification element received and acquired by said receiving means from wireless signals of the downlink and the configuration of said mobile terminal, and make the mobile terminal access the wireless communication system with the wireless communication scheme if the mobile terminal supports the wireless communication scheme corresponding to said value of the system type identification element.

17. The mobile terminal of claim 16, wherein when the status of the mobile terminal is power-on, said value of the system type identification element is the value of system type identification element of the current cell and said wireless communication scheme is the wireless communication shceme employed by the current cell.

18. The mobile terminal of claim 16, wherein when a state of the mobile terminal is cell handover, said value of the system type identification element is the value of system type identification element of a adjacent cell and said wireless communication scheme is the wireless communication scheme employed by the adjacent cell.

19. The mobile terminal of claim 18, wherein if the mobile terminal cannot access the wireless communication scheme corresponding to the value of the system type identification element of the adjacent cell, a cell handover will not be executed.

20. The mobile terminal of claim 16, wherein said downlink includes broadcast channel.
